(19) United States
(12) Patent Application Publication
(10) Pub. No.: US 2010/0312436 A1
(43) Pub. Date: Dec. 9, 2010

(54) METHOD AND SYSTEM FOR CONTROLLING A WORK VEHICLE AND WORK VEHICLE

(76) Inventor: Sverker Hartwig, Taby (SE)

Correspondence Address: Mark P Stone, 25 Third Street 4th floor, Stamford, CT, 06905, US

(21) Appl. No.: 12/734,816

(22) PCT Filed: Dec. 17, 2008
(86) PCT No.: PCT/SE2008/000716

§ 371 Date: May 24, 2010

(30) Foreign Application Priority Data
Dec. 21, 2007 (SE) 0702861-6

(51) Int. Cl. G06F 19/00

(52) U.S. Cl. 701/50

(57) ABSTRACT

A method and a system for controlling braking of a waist steered engine powered work vehicle (1) having wheels and a steering joint (4) in the form of a bucket loader having a loading bucket and at least two wheel axes, said vehicle exhibiting: individually activated braking units (16-19) for each one of the wheels (2a,b,3a,b), and a transmission including a driving gear individually (13) for transferring of torque to a propeller axis (11) between the wheel axes (20,21), and a differential gear (14,15) between the propeller axis and each one of the wheel axes as well as a rotational rigid cardan joint in the area of the steering joint. At least one is-value is sensed or calculated for at least one condition variable influencing the vehicle, which is representative for parasitic torque occurring in the vehicle transmission during braking, and outgoing from said is-value at least one braking unit (16-19) is controlled for reducing the magnitude of applied braking force and thereby for reduction of said parasitic torque. The invention also concerns a work vehicle (1).

### FIELD OF THE INVENTION

The present invention concerns a method for controlling braking of a work vehicle according to the preamble of claim 1. The invention also concerns a system for controlling braking of a work vehicle and a work vehicle including such a system.

### BACKGROUND OF THE INVENTION

Heavy work vehicles for e.g. loading work in mines underground are during operation subject to uneven and varying grounds. The grounds in these environments often exhibit bad driveability because of water, mud, gravel etc., which leads to low friction for the vehicle. Passages with differences in altitude being passed with great loads are demanding for the driving as well as the braking systems. Because of high production requirements, there are at the same time high demands on the working life of the work vehicle as well as the manoeuvrability such as for example in respect of driving in curves and short braking distances.

The work vehicles intended according to the present invention are often but not exclusively underground vehicles, having waist steering with at least one front and one rear wheel axis. The front as well as the rear wheel axis is driven over differential gears. The vehicles can be driven in narrow galleries and around curves having small curve radiuses. Further, the vehicles are subject to great loads, high propulsive power and fast retardations/accelerations with high but strongly varying wheel loads.

Slipping tyres means besides deterred loading ability also increase risk of tyre wear and risk of tyre failure because being extra subject to damages caused by sharp blast stones etc.

U.S. Pat. No. 5,865,512 describes a control system wherein driven wheels are monitored and slipping wheels are braked to a level where more effective drive contact with the ground can be expected.

### AIM AND MOST IMPORTANT FEATURES OF THE INVENTION

It is an aim to provide a method as mentioned initially wherein is provided a further development of the methods for braking vehicles according to the background art. This aim is obtained according to the invention by:—that at least one is-value is sensed or calculated for at least one condition variable affecting the vehicle, which is representative for parasitic torque occurring in the vehicle transmission during braking, and that outgoing from said is-value at least one braking unit is controlled for reducing the magnitude of applied braking force and thereby for reduction of said parasitic torque.

This method is a great advantage in cases of operation where there is a risk of so called “parasitic torque”, for example with heavily front loaded machine with lightening rear wheels, driving downhill and/or with slipping wheels because of slippery ground.

When, for example, a heavily loaded vehicle with a front bucket is braked in a descent, a very great part of the vehicle weight lies on the front wheels whereas the rear wheels take up a substantially smaller part of the load if any. For that reason these wheels are not capable of transferring any considerable braking force to the ground.

It should be noted that with the term “outgoing from said is-value” here is also intended to be included that the respective braking unit is controlled after previous adapting, transferring, comparing and other handling of the is-value before it is used for control.

A previously known work vehicle according to the background art lacks differential gear between the front and rear parts of the propeller (cardan) axis. The reason for this is that such a (cardan) differential gear would require high costs and require undesired great space. Since it further would be detrimental to the braking and driving ability of the vehicle, such a component is not desired in this type of vehicle. Instead there is arranged a rotationally rigid universal joint or cardan joint in the propeller axis in the region of the steering joint of the vehicle. During driving as well as braking of such a vehicle, the front wheel axis and the rear wheel axis will therefore be driven with the same rotational speeds. This results in that during said braking operation, where the rear wheels are not in the position of transferring any important braking power to the ground, the rear braking units belonging to these wheels will be rotationally driven by the front wheels over all transmission elements therebetween and that these rear braking units will contribute to braking the front wheels. The result of this is that great internal, what here is characterized as parasitic torques, will occur in the transmission, which strains hub reduction gears, wheel axis differential gears and propeller axis components.

An internal/parasitic torque is a superimposed torque in the propulsive system which transports power, i.e. torque, from a first wheel axis to a second wheel axis. This in excess of an ideal condition where the front part of the propeller axis, being connected to the front axis, and rear part, connected to the rear axis, have the same torque and direction, where the direction is defined from whether the torque is propulsive or braking, (i.e. that for example the propulsive torque from the engine is distributed approximately equally between the front and rear axis). A typical case is during hard braking, when the rear wheels, because of low friction against the ground, are rotationally driven not by the contact between wheels and ground but by the propeller axis. The torque which is braked by the rear wheels is in this case transported from the ground to the front wheels and rearwards all the way through the propulsive system to the brakes positioned at the rear wheels.

Through the invention it is possible that the braking power which actuates wheels that are lightly loaded against the ground and even “lifted wheels” can be reduced and that braking of the vehicle instead at the major part will be in respect of the wheels that take up the overwhelming part of the weight from the loaded vehicle. Hereby the parasitic torque in the transmission is reduced and axes and propeller axes as well as intermediate ordinary differential gears etc. will be protected from the harmful load which otherwise would occur.

In practice, the brake force distribution can be dependent at a higher or lower degree of (for example being proportional to) the existing load on the specific wheel or the specific wheel axis.

Braking powers are preferably applied onto the respective wheels that are preferably measured such that the braking powers are functions of the load being present on the respective axis. It is preferred that in respect of load below such a level on a certain axis, no braking power is applied on the wheels of this axis.

The distribution of braking powers are preferably calculated outgoing from at least anyone condition variable the group: load in the bucket, the work vehicle's inclination in respect of a horizontal plane, torque transmitted in the transmission, twist of a component being part of the transmission, the load each one of the said at least two wheel axes are subject to, acceleration and retardation forces influencing the work vehicle.

Hereby load in the bucket can be calculated or be detected through any per se known method including deformation measuring through for example strain gauges on a carry arm, hydraulic pressure in a lifting cylinder etc.

The work vehicle's inclination in respect of a horizontal plane can be detected through an inclinometer.

Torque transferred in the transmission can be calculated directly through torque sensors in the transmission or indirectly through for example strain gauges for measuring twist of a component in the transmission.

The load each one of said at least two wheel axes is subject to can be sensed by load detection cells being placed in the suspension or indirectly be calculated through accessible information about bucket load, vehicle weight etc.

Acceleration and retardation forces influencing the work vehicle can be sensed or be estimated with accelerometers in combination with weight data.

When the condition variable is anyone from the group: the load each one of said wheel axes is subject to, load in the bucket; preferably braking loads are applied for the respective wheel that are measured such that the braking forces are functions of the present calculated or measured load. When it concerns the load each one of the said at least two wheel axis is subject to, in particular such that the braking loads are functions of the load being present on the respective axis. This gives simple calculation and control of the system according to the invention.

When the condition variable is anyone from the group: the inclination of the work vehicle in respect of a horizontal plane, acceleration and retardation forces influencing the work vehicle, braking forces are preferably applied for the respective wheel that are measured such the braking forces are functions of calculated or measured is-value.

During certain circumstances it is suitable and preferred to set respectively calculate a should-value corresponding to said is-value for the condition variable outgoing from a desired vehicle operation, wherein parasitic torque is below a certain level. Further, said is-value and should-value are compared in order to create a representation describing deviation and is controlled at least one braking unit in respect of the magnitude of applied braking force, in order to reduce said deviation thereby reducing said parasitic torque. This is particularly preferred when the condition variable is anyone from the group: torque transferred in the transmission, twist of a component in the transmission. According to this aspect the should-value is set to what is determined to be transferred torque respectively a twist of a component in the transmission which is acceptable.

Altogether important advantages of the invention are that the lifetime of important components of the work vehicle can be increased, that the dimensions of these components can be reduced and that controllability during braking can be increased. Thereby also the total economy and productivity of the vehicle is improved.

The invention also concerns a system for controlling braking of a motor powered work vehicle with wheels and waist steered with a steering joint and a work vehicle including a system according to the above.

Advantages corresponding to the method features are obtained through the corresponding device features.

### BRIEF DESCRIPTION OF DRAWINGS

The invention will now be described by way of embodiments at the background of the drawings, wherein,

FIG. 1 diagrammatically shows a work vehicle according to the invention standing on the ground,

FIG. 2 diagrammatically shows the drive components of the work vehicle according to FIG. 1,

FIG. 3 diagrammatically shows the work vehicle according to FIG. 1 in an operational position, wherein the invention is applicable, and

FIG. 4 diagrammatically shows a method sequence according to the invention.

### DESCRIPTION OF EMBODIMENTS OF THE INVENTION

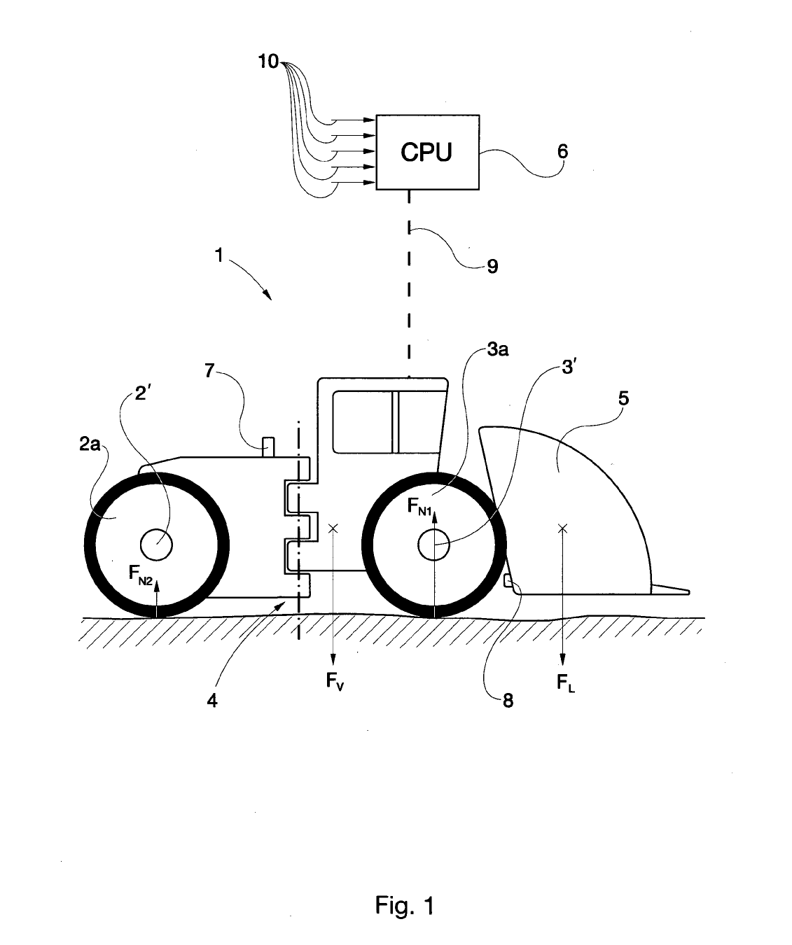

In FIG. 1 reference numeral 1 indicates a waist steered work vehicle with wheels intended for loading work in an underground environment, in galleries, tunnels and the like. The work vehicle 1 has front a rear wheels, wherein one wheel, as is shown indicated in 2a and has a rear wheel axis 2′. A front wheel 3a is shown which has a front wheel axis 3′. The vehicle has in one per se known manner a centrally positioned steering joint 4 with a vertical axis.

The work vehicle 1 is provided with a relatively very large loading bucket 5 for loading blast stone, loosened ore and the like. Control of the work vehicle is had over a control unit or CPU 6, which has a control bus 9 for communicating with different functions in the vehicle. Incoming signals from different sensors and from components influenced by the driver are passed to entries of the control unit 1 which are indicated with arrows 10.

In particularly is shown in FIG. 4 an accelerometer 7, which senses accelerations and retardations that the vehicle is subject to during operation and a load sensor 8, which is arranged to sense load being present in the loading bucket 5.

In FIG. 1 further are illustrated some of the forces influencing the vehicle, namely F_{V}, which is the vehicles gravity force component; F_{L}, which is the gravity force component of the possible load; F_{N1}, which is the normal force on the right front wheel 3a and F_{N2}, which is the normal force of the rear right wheel 2a. In a theoretic symmetrical position, the respective normal forces on the left (not shown) wheels are like by pair.

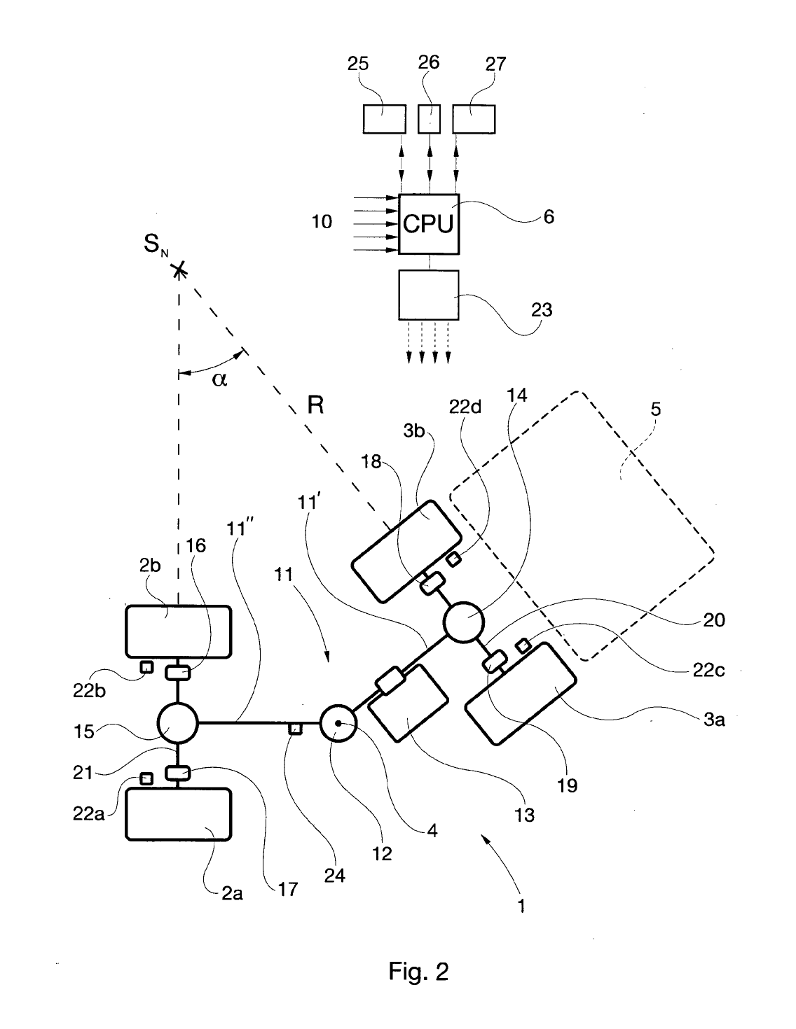

In FIG. 2 the drive components of the work vehicle 1 are shown with a propulsion gear 13, which transfers the propulsive power from a (not shown) engine to a propeller (cardan) axis 11. The propeller axis 11 exhibits in the area of the steering joint (see FIG. 1) 4 a rotationally rigid cardan joint 12, which means that a front part 11′ of the propeller axis 11 as well as a rear part 11″ of the propeller axis 11 are rotating synchronous with each other.

The front part 11′ of the propeller axis 11 is over a front differential gear 14 connected to a front wheel axis 20, which in turn drives both front wheels 3a and 3b. The rear part 11″ of the propeller axis 11 drives over a rear differential gear 15 a rear wheel axis 21, which in turn drives the two rear wheels 2a and 2b.

Associated with each wheel is an individually activated braking unit 16-19. With 22a-d are indicated sensors associated with each one of the wheels in order to transmit a signal representative for the rotational speed of each wheel.

Each sensor 22a-d communicates with a control unit, CPU 6, which also communicates with or includes a control circuit 23 intended for brake control, which has the ability of emitting signals for individually activating each braking unit 16-19.

In FIG. 2 is shown that the work vehicle 1 with the shown steering range, which could be maximal steering range, has a natural turning centre, which is indicated with S_{N}. This means that with normal driving of a normal ground and with the shown steering range, the vehicle 1 will turn around the point S_{N} with a turning radius R.

The vehicle speed can be calculated or measured through one per se known not shown unit. An angular detector 24 is arranged in the area of the steering joint.

When using the vehicle it is influenced, also when it stands still, of a number of different forces and opposing forces in equilibrium. The forces are for example the gravitational force, dynamic mass forces etc. Opposing forces act on the contact points between the vehicle and the ground: on the wheels and on other possible contact points against the ground, for example through the bucket.

During static equilibrium, the vehicle is going with maintained speed in maintained direction with a maintained angular speed.

Because of the propeller axis having a rotationally rigid joint in the area of the steering joint and thereby the wheel axes are rotating in synchronisation, in certain operational cases, such as indicated above, parasitic torque can occur, for example with heavily front loaded machine with lightened rear wheels. Except from braking of a heavily loaded vehicle in a decline, where a very large part of the vehicle weight lies on the front wheels, parasitic moments can basically occur during each braking when differentiated brake force transfer can occur from the different wheels to the ground. This is most significant when any of the wheels of a wheel axis has lower friction against the ground and particularly when it concerns a less loaded wheel axis.

The maximal possible friction force at each wheel statically and dynamically is in turn dependent on the vertical normal force multiplied with the friction coefficient between the tyre and the ground. Both the vertical force and the coefficient of friction vary very much. The vertical force for example depends on the inclination of the vehicle, the acceleration of the vehicle and the static wheel load that comes from fully loaded or even empty bucket etc.

In a number of exciting real cases, the vertical force in one wheel can come close to zero or even be zero. At the same time the coefficient of friction varies very much on the substrate where the present vehicle is used.

The invention does not only concern an “on-off”-method but a possibility of a continuous controllable increasing/reducing braking power in order to continuously reduce also smaller parasitic torques. The vehicle can be driven with an electric or diesel engine or in any other way, and have two or more wheel axes. The work vehicle can also be provided with differential gear brake/lock.

Referring to FIG. 2, the system includes a condition circuit 25 in order to sense or calculate at least one is-value or at least one condition variable affecting the vehicle, preferably a calculating/setting unit 26 for calculating/setting a should-value corresponding to said is-value outgoing from desired operation of the vehicle, further, equally preferably, a comparing unit 27 for comparing said is-value and should-value in order to create a representation describing deviation, and the control circuit 23 for controlling at least one braking unit in respect of the size of applied braking force. Said condition circuit, calculating unit, comparing unit and control circuit are suitably integral parts of the CPU but can also be interconnected separate units such as is indicated in FIG. 2 for clarity.

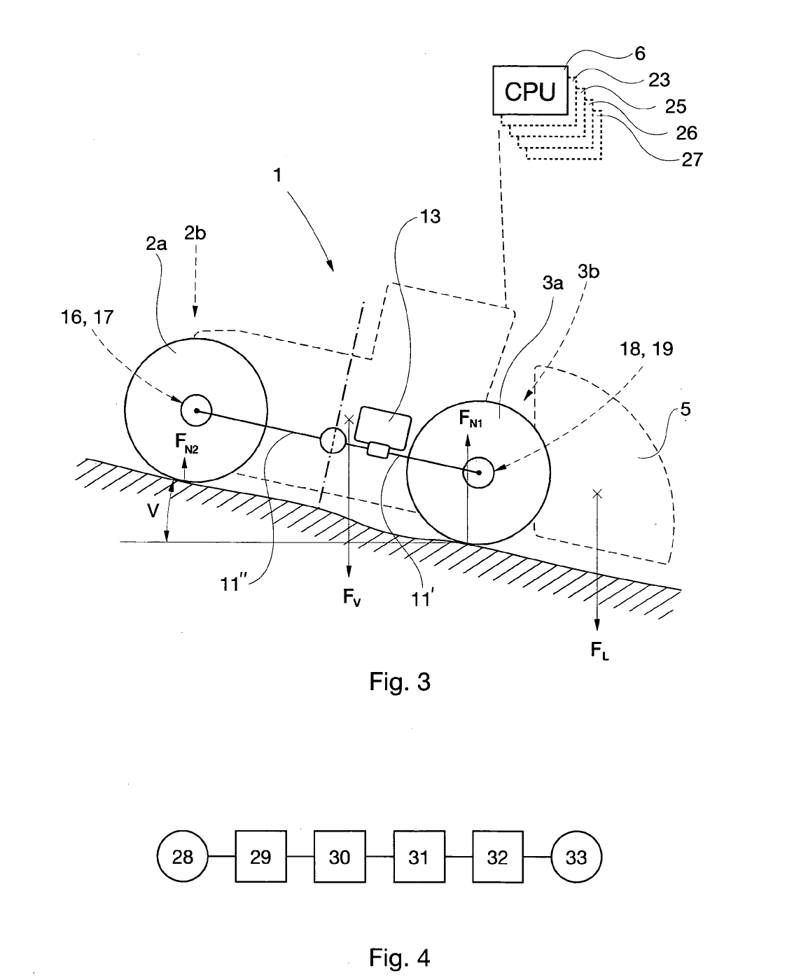

In FIG. 3 a work vehicle is shown going downwardly on a road inclining with the angle v. The forces acting on the vehicle are basically the same as in FIG. 1, except from that the rear wheels 2a, 2b almost lack contact with the ground and therefore are influenced by only a small normal force. All possible braking force in practice thus must go over the front wheels 3a, 3b.

What now would occur in such an operational case in respect of braking of a work vehicle according to the background art is that the rear braking units as well as the front braking units would be applied with braking forces. Since the rear wheel axis would be rotationally driven by the front wheels which lie against the ground, because of the braking of the rear wheels, a parasitic torque will occur in the transmission, all the way through (also see FIG. 2) the braking units 16, 17, over the wheel axis 21, over the differential gear 15, over the rear part of the propeller axis 11″, over the cardan joint 12, over the front part of the propeller axis 11′, over the differential gear 14 and over the wheel axis 20. All these components (and possible also others) would be affected by this parasitic torque. According to the invention, instead suitable braking force will be applied to the front braking units 18, 19 and the braking force on the rear braking unit 16, 17 will be reduced, wherefore the parasitic torque will be reduced correspondingly or even be set to zero.

FIG. 4 shows a block diagram over an exemplary method sequence according to the invention. Position 28 indicates the start of the sequence. Position 29 indicates sensing or calculating of (at least) one is-value or a condition variable such as torque transferred in the transmission.

Position 30 indicates that the is-value is compared to a predetermined should-value for the case of operation in order to create a representation describing deviation.
Position 31 indicates transmitting the representation of deviation to a control circuit, which in case the deviation exceeds a certain predetermined value, controls the rear braking units for reduction of the braking force.
Position 32 indicates return to position 29.
Position 33 indicates the end of the sequence.
Preferably more than one condition variable is considered during the calculations. For example load in the bucket as well as inclination of the work vehicle 1 in respect of a horizontal plane or torque transferred in the transmission.

In certain cases of operations the present loading state and friction between wheel and ground allows a relatively acceptable level of parasitic torque to be introduced in the transmission also without the use of this invention. This can be the case with lower loads, driving upwardly, dry ground etc. The invention is, however, active also during such operational cases by in an advantageous way distributing actuating forces between the wheel axes and thereby reduce transmission wear.

The load that the wheel axes are subject to can be sensed or calculated in analogy with what is said above in respect of force transferred from wheels. Applied braking power for the respective wheel can be calculated outgoing from a pressure value in a fluid circuit.

Altogether these variables can be sensed or calculated simply and cost effectively.

It is not excluded that as ground for calculation also is considered at least anyone from the group; the present slip of each wheel, tyre size, tyre wear, which gives increased position for the control. With a load below a certain level on a certain axis 20, 21, it could be arranged that no braking force is applied for wheels 2a, b, 3a, b on that axis.

1. Method for controlling braking of a waist steered engine powered work vehicle (1) having wheels and a steering joint (4) in the form of a bucket loader having a loading bucket and at least two wheel axes, said vehicle exhibiting:
Individually activated braking units (16-19) for each one of the wheels (2a, b, 3a, b), and
a transmission including a driving gear (13) for transferring of torque to a propeller axis (11) between the wheel axes (20, 21), and a differential gear (14, 15) between the propeller axis and each one of the wheel axes as well as a rotational rigid cardan joint in the area of the steering joint,
characterized in
that at least one is-value is sensed or calculated for at least one condition variable influencing the vehicle, which is representative for parasitic torque occurring in the vehicle transmission during braking, and
that outgoing from said is-value at least one braking unit (16-19) is controlled for reducing the magnitude of applied braking force and thereby for reduction of said parasitic torque.

2. Method according to claim 1, characterized in that said condition variable is any one from the group: load in the bucket, the inclination of the work vehicle (1) in respect of a horizontal plane, torque transferred in the transmission, twist of a component being part of the transmission, the load of each one of said at least two wheel axes (20, 21) are subject to, acceleration and retardation forces influencing the work vehicle (1).

3. Method according to claim 2, wherein the condition variable is any one from the group: the load each one of said at least two axes (20, 21) are subject to, load in the bucket, characterized in that braking forces are applied to the respective wheels (2a, b, 3a, b) which are measured such that the brake forces are functions of the present calculated or measured load.

4. Method according to claim 2, wherein the condition variable is any one from the group: the inclination of the work vehicle (1) in respect of a horizontal plane, acceleration and retardation forces influencing the work vehicle (1), characterized in that braking powers are applied to the respective wheel (2a, b, 3a, b) which are measured such that the braking forces are functions of calculated or measured is-value.

5. Method according to claim 2, characterized in
that a should-value corresponding to said is-value is set or calculated outgoing from desired operation of the vehicle (1), wherein parasitic torque is below a certain level,
that said is-value and should-value are compared for creating a representation describing deviation,
that at least one braking unit (16-19) is controlled in respect of the magnitude of applied braking force in order to reduce said deviation and thereby reduction of said parasitic torque.

6. Method according to claim 5, wherein the condition variable is any one from the group: torque transferred in the transmission, twist of a component in the transmission.

7. System for controlling braking of a waist steered engine powered work vehicle (1) having wheels and a steering joint (4) in the form of a bucket loaded with at least two wheel axes and a loading bucket, said vehicle exhibiting:
individually activated braking units (16-19) for each one of the wheels (2a, b, 3a, b), and a transmission including a driving gear (13) for transfer of torque to a propeller axis (11) between the wheel axes (20, 21) with a differential gear (15) between the propeller axis and each one of the wheel axes and a rotational rigid cardan joint in the area of the steering joint,
characterized by
a condition circuit for sensing or calculating at least one is-value for at least one condition variable affecting the vehicle which is representative of parasitic torque occurring in the vehicle transmission during braking, and
a control circuit in order, outgoing from said is-value, to control at least one braking unit (16-19) for reducing the magnitude of applied braking force and thereby for reduction of said parasitic torque.

8. System according to claim 7, characterized in that the condition circuit is arranged to sense or calculate said is-value for any condition variable from the group: load in the bucket, inclination of the work vehicle (1) in respect of a horizontal plane, torque transferred in the transmission, twist of a component in the transmission, the load each one of said at least two wheel axes (20, 21) is subject to, acceleration and retardation forces influencing the work vehicle (1).

9. System according to claim 8, wherein the condition variable is any one from the group: the load each one of said at least two wheel axes (20, 21) is subject to, load in the bucket, characterized in that the control circuit is arranged to control the respective braking unit such that braking forces are applied for the respective wheel (2a, b, 3a, b) which are measured such that the braking forces are functions of the present calculated or measured load.

10. System according to claim 8, wherein the condition variable is any one from the group: the inclination of the work vehicle (1) in respect of a horizontal plane, acceleration and retardation forces influencing the work vehicle (1), characterized in that the control circuit is arranged to control the respective braking unit such that braking forces are applied for the respective wheel (2a, b, 3a, b) which are measured such that the braking forces are functions of calculated or detected is-value.

11. System according to claim 8, characterized by
a calculating/setting unit for setting or calculating a should-value corresponding to said is-value outgoing from a desired operation of the vehicle (1), wherein parasitic torque is below a certain level,
a comparing unit for comparing said is-value and should-value and for creating a representation describing deviation, and
the control circuit being arranged to control at least one braking unit (16-19) in respect of the magnitude of applied braking force, in order to reduce said deviation and thereby reduction of said parasitic torque.

12. System according to claim 11, wherein the condition variable is any one from the group: torque transferred in the transmission, twist of a component in the transmission.

13. Work vehicle including a system according to claim 7.

14. Work vehicle including a system according to claim 8.

15. Work vehicle including a system according to claim 9.

16. Work vehicle including a system according to claim 10.

17. Work vehicle including a system according to claim 11.

18. Work vehicle including a system according to claim 12.
